(19) United States
(12) Patent Application Publication
(10) Pub. No.: US 2025/0324291 A1
(43) Pub. Date: Oct. 16, 2025

(54) DATA COLLECTION METHOD AND APPARATUS, TERMINAL, AND NETWORK-SIDE DEVICE

(71) Applicant: VIVO MOBILE COMMUNICATION CO., LTD., Dongguan (CN)

(72) Inventors: Tong ZHOU, Dongguan (CN); Yuan SHI, Dongguan (CN); Peng SUN, Dongguan (CN); Ang YANG, Dongguan (CN)

(73) Assignee: VIVO MOBILE COMMUNICATION CO., LTD., Dongguan (CN)

(21) Appl. No.: 19/253,676

(22) Filed: Jun. 27, 2025

Related U.S. Application Data
(63) Continuation of application No. PCT/CN2023/140868, filed on Dec. 22, 2023.

(30) Foreign Application Priority Data
Dec. 29, 2022 (CN) 202211714898.X

(51) Int. Cl. H04W 24/06; H04W 12/02

(52) U.S. Cl. CPC H04W 24/06; H04W 12/02

(57) ABSTRACT

A data collection method, a terminal, and a network-side device are provided. The data collection method includes: constructing a first sample dataset, where first sample data in the first sample dataset includes sensitive information of the first device; determining a first output of a first model based on the first sample dataset, where the first model is used for performing feature extraction on the sensitive information of the first device; and sending first information to a second device. The first information is determined based on the first output of the first model, and is used for the second device to determine target sample data that includes first target information and second target information. The first target information is information determined based on a first output corresponding to the first sample data. The second target information is determined based on second sample data including sensitive information of the second device.

### CROSS-REFERENCE TO RELATED APPLICATIONS

This application is a continuation of International Application No. PCT/CN2023/140868, filed on Dec. 22, 2023, which claims priority to Chinese Patent Application No. 202211714898.X filed on Dec. 29, 2022. The entire contents of each of the above-referenced applications are expressly incorporated herein by reference in its entirety.

### TECHNICAL FIELD

This application relates to the field of communication technologies, and more specifically, to a data collection method and apparatus, a terminal, and a network-side device.

### BACKGROUND

In a mobile communication system, Artificial Intelligence (AI) begins to be combined with an increasing number of use cases, for example, AI-based channel state information (CSI) feedback compression, AI-based beam management, and AI-based positioning at a physical layer.

Currently, in AI-based beam management or beam prediction, from the perspective of privacy, a base station or User Equipment (UE) does not want to expose its sensitive beam or antenna information. During data collection, detailed information of a transmit beam and detailed information of a receive beam cannot be obtained at the same time, leading to low accuracy of model-based beam prediction. Therefore, in the conventional technology, accuracy of an AI model is low.

### SUMMARY

Embodiments of this application provide a data collection method and apparatus, a terminal, a network-side device,.

According to a first aspect, a data collection method is provided, including:

A first device constructs a first sample dataset, where first sample data in the first sample dataset includes sensitive information of the first device;
the first device determines a first output of a first model based on the first sample dataset, where the first model is used for performing feature extraction on the sensitive information of the first device; and
the first device sends first information to a second device, where the first information is determined based on the first output of the first model, and the first information is used for the second device to determine target sample data, where
a group of target sample data includes first target information and second target information, the first target information is information determined based on a first output corresponding to the first sample data, the second target information is determined based on second sample data, and the second sample data includes sensitive information of the second device.

According to a second aspect, a data collection method is provided, including:

A second device receives first information from a first device, where the first information is determined based on a first output of a first model, an input of the first model is determined based on a first sample dataset, and first sample data in the first sample dataset includes sensitive information of the first device; and
the second device determines target sample data based on the first information, where
a group of target sample data includes first target information and second target information, the first target information is information determined based on a first output corresponding to the first sample data, the second target information is determined based on second sample data, and the second sample data includes sensitive information of the second device.

According to a third aspect, a data collection apparatus is provided, including:
a sample construction module, configured to construct a first sample dataset, where first sample data in the first sample dataset includes sensitive information of a first device;
a first determining module, configured to determine a first output of a first model based on the first sample dataset, where the first model is used for performing feature extraction on the sensitive information of the first device; and
a first sending module, configured to send first information to a second device, where the first information is determined based on the first output of the first model, and the first information is used for the second device to determine target sample data, where
a group of target sample data includes first target information and second target information, the first target information is information determined based on a first output corresponding to the first sample data, the second target information is determined based on second sample data, and the second sample data includes sensitive information of the second device.

According to a fourth aspect, a data collection apparatus is provided, including:
a second receiving module, configured to receive first information from a first device, where the first information is determined based on a first output of a first model, an input of the first model is determined based on a first sample dataset, and first sample data in the first sample dataset includes sensitive information of the first device; and
a second determining module, configured to determine target sample data based on the first information, where
a group of target sample data includes first target information and second target information, the first target information is information determined based on a first output corresponding to the first sample data, the second target information is determined based on second sample data, and the second sample data includes sensitive information of the second device.

According to a fifth aspect, a terminal is provided, where the terminal includes a processor and a memory, the memory stores a program or instructions capable of running on the processor, and when the program or the instructions is/are executed by the processor, the steps of the method according to the first aspect are implemented.

According to a sixth aspect, a terminal is provided, including a processor and a communication interface.

When the terminal is a first device, the processor is configured to: construct first sample dataset, where first sample data in the first sample dataset includes sensitive information of the first device; and determine a first output of a first model based on the first sample dataset, where the first model is used for performing feature extraction on the sensitive information of the first device; and
the communication interface is configured to send first information to a second device, where the first information is determined based on the first output of the first model, and the first information is used for the second device to determine target sample data, where
a group of target sample data includes first target information and second target information, the first target information is information determined based on a first output corresponding to the first sample data, the second target information is determined based on second sample data, and the second sample data includes sensitive information of the second device.

When the terminal is a second device, the communication interface is configured to receive first information from a first device, where the first information is determined based on a first output of a first model, an input of the first model is determined based on a first sample dataset, and first sample data in the first sample dataset includes sensitive information of the first device; and
the processor is configured to determine target sample data based on the first information, where a group of target sample data includes first target information and second target information, the first target information is information determined based on a first output corresponding to the first sample data, the second target information is determined based on second sample data, and the second sample data includes sensitive information of the second device.

According to a seventh aspect, a network-side device is provided, where the network-side device includes a processor and a memory, the memory stores a program or instructions capable of running on the processor, and when the program or the instructions is/are executed by the processor, the steps of the method according to the second aspect are implemented.

According to an eighth aspect, a network-side device is provided, including a processor and a communication interface.

When the network-side device is a first device, the processor is configured to: construct first sample dataset, where first sample data in the first sample dataset includes sensitive information of the first device; and determine a first output of a first model based on the first sample dataset, where the first model is used for performing feature extraction on the sensitive information of the first device; and
the communication interface is configured to send first information to a second device, where the first information is determined based on the first output of the first model, and the first information is used for the second device to determine target sample data, where
a group of target sample data includes first target information and second target information, the first target information is information determined based on a first output corresponding to the first sample data, the second target information is determined based on second sample data, and the second sample data includes sensitive information of the second device.

When the network-side device is a second device, the communication interface is configured to receive first information from a first device, where the first information is determined based on a first output of a first model, an input of the first model is determined based on a first sample dataset, and first sample data in the first sample dataset includes sensitive information of the first device; and
the processor is configured to determine target sample data based on the first information, where a group of target sample data includes first target information and second target information, the first target information is information determined based on a first output corresponding to the first sample data, the second target information is determined based on second sample data, and the second sample data includes sensitive information of the second device.

According to a ninth aspect, a communication system is provided, including a terminal and a network-side device, where the terminal may be configured to perform the steps of the data collection method according to the first aspect or the second aspect, and the network-side device may be configured to perform the steps of the data collection method according to the second aspect or the first aspect.

According to a tenth aspect, a readable storage medium is provided, where the readable storage medium stores a program or instructions, and when the program or the instructions is/are executed by a processor, the steps of the method according to the first aspect are implemented, or the steps of the method according to the second aspect are implemented.

According to an eleventh aspect, a chip is provided, where the chip includes a processor and a communication interface, the communication interface is coupled to the processor, and the processor is configured to run a program or instructions to implement the steps of the method according to the first aspect, or implement the steps of the method according to the second aspect.

According to a twelfth aspect, a computer program or program product is provided, where the computer program or program product is stored in a storage medium, and the computer program or program product is executed by at least one processor to implement the steps of the method according to the first aspect, or implement the steps of the method according to the second aspect.

In the embodiments of this application, a first model is set on a first device, feature extraction is performed on sensitive information of the first device by using the first model to obtain a first output, and second information is sent to a second device based on the first output. In this way, the second device can obtain the sensitive information of the first device without exposing sensitive information of the second device. Therefore, integrity of data collection can be improved, to improve reliability of model training and improve accuracy of a trained model.

### BRIEF DESCRIPTION OF THE DRAWINGS

FIG. 1 is a schematic diagram of a network structure to which embodiments of this application are applicable;

FIG. 2 is a first schematic flowchart of a data collection method according to an embodiment of this application;

FIG. 3A is a first diagram of a network scenario to which a data collection method according to an embodiment of this application is applicable;

FIG. 3B is a second diagram of a network scenario to which a data collection method according to an embodiment of this application is applicable;

FIG. 4 is a third diagram of a network scenario to which a data collection method according to an embodiment of this application is applicable;

FIG. 5 is a fourth diagram of a network scenario to which a data collection method according to an embodiment of this application is applicable;

FIG. 6 is a second schematic flowchart of a data collection method according to an embodiment of this application;

FIG. 7 is a third schematic flowchart of a data collection method according to an embodiment of this application;

FIG. 8 is a fourth schematic flowchart of a data collection method according to an embodiment of this application;

FIG. 9 is a fifth schematic flowchart of a data collection method according to an embodiment of this application;

FIG. 10 is a sixth schematic flowchart of a data collection method according to Sat embodiment of this application;

FIG. 11 is a first diagram of a structure of a data collection apparatus according to an embodiment of this application;

FIG. 12 is a second diagram of a structure of a data collection apparatus according to an embodiment of this application;

FIG. 13 is a diagram of a structure of a communication device according to an embodiment of this application;

FIG. 14 is a diagram of a structure of a terminal according to an embodiment of this application; and

FIG. 15 is a diagram of a structure of a network-side device according to an embodiment of this application.

### DETAILED DESCRIPTION

The following clearly describes the technical solutions in the embodiments of this application with reference to the accompanying drawings in the embodiments of this application. Clearly, the described embodiments are some but not all of the embodiments of this application. All other embodiments obtained by persons of ordinary skill in the art based on the embodiments of this application fall within the protection scope of this application.

The terms “first”, “second”, and the like in this specification and the claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not limit the number of objects. For example, there may be one or more first objects. In addition, in this specification and the claims, “and/or” indicates at least one of connected objects, and the character “/” generally indicates an “or” relationship between contextually associated objects.

The term “indication” in this specification and the claims of this application may be an explicit indication or an implicit indication. The explicit indication may be understood as that a sender explicitly notifies, in a sent indication, a receiver of an operation that needs to be performed or a request result. The implicit indication may be understood as that a receiver performs determining based on an indication sent by a sender, and determines, based on a determining result, an operation that needs to be performed or a request result.

It should be noted that technologies described in the embodiments of this application are not limited to a Long Term Evolution (LTE)/LTE-Advanced (LTE-A) system, and may also be applied to other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application are often used interchangeably, and the technology described herein may be used in the aforementioned systems and radio technologies as well as other systems and radio technologies. In the following descriptions, a New Radio (NR) system is described for an illustration purpose, and NR terms are used in most of the following descriptions, but these technologies may also be applied to applications other than an NR system application, for example, a 6^{th} Generation (6G) communication system.

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet personal computer, a laptop computer or referred to as a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), smart household (a home appliance with a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. Provided that the same technical effect is achieved, the base station is not limited to a specific technical term. It should be noted that a base station in an NR system is used only as an example for description in the embodiments of this application, but a specific type of the base station is not limited.

The following describes in detail a data collection method provided in the embodiments of this application with reference to the accompanying drawings and by using some embodiments and application scenarios thereof.

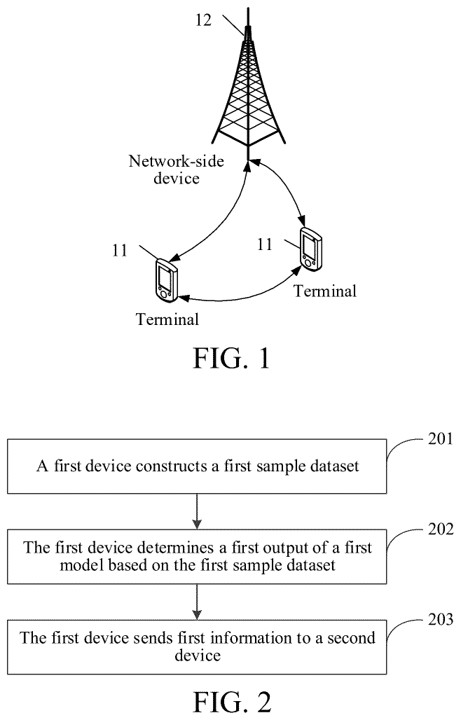

With reference to FIG. 2, an embodiment of this application provides a data collection method. As shown in FIG. 2, the data collection method includes the following steps:

Step 201: A first device constructs a first sample dataset, where first sample data in the first sample dataset includes sensitive information of the first device.

In this embodiment of this application, the first device may be understood as a segmented inference assistance device or a split inference assistance device, and a second device may be understood as a joint inference device. The first device may be a base station or a terminal. When the first device is a base station, the second device is a terminal. When the first device is a terminal, the second device is a base station.

Step 202: The first device determines a first output of a first model based on the first sample dataset, where the first model is used for performing feature extraction on the sensitive information of the first device.

In this embodiment of this application, the first device may use the sensitive information of the first device as an input of the first model, or use information obtained by preprocessing the sensitive information of the first device as an input of the first model, to obtain an output of the first model.

Step 203: The first device sends first information to the second device, where the first information is determined based on the first output of the first model, and the first information is used for the second device to determine target sample data.

A group of target sample data includes first target information and second target information. The first target information is information determined based on a first output corresponding to the first sample data. The second target information is determined based on second sample data. The second sample data includes sensitive information of the second device.

In this embodiment of this application, after obtaining the first output of the first model, the first device may send the first information to the second device based on the first output of the first model, so that the second device determines the target sample data based on the first information.

It should be understood that, when the first model is used in a beam management process, an output of the first model may be understood as an output of the first model that is associated with a reference resource. For example, when the first device is UE, a base station may send measurement resource configuration information to the terminal. The terminal performs beam measurement based on a measurement resource configured by the measurement resource configuration information, records corresponding sensitive information, for example, sensitive information related to a receive beam, and finally inputs, to the first model, the sensitive information corresponding to the measurement resource, to obtain a first output associated with the measurement resource. For another example, when the first device is a base station, before sending measurement resource configuration information to a terminal, the base station first inputs, to the first model, sensitive information corresponding to a base station transmit beam corresponding to each measurement resource, to obtain a first output associated with each measurement resource.

It should be noted that the first target information and the second target information may be understood as a first part of data used for model inference. In addition to the first part of data, the target sample data may further include a second part of data used for assisting in determining validity of the first part of data. For example, the second part of data may include a version of the first model and an output length of the first model. Certainly, in some embodiments, the first part of data may further include other data, for example, may include measured beam quality. Further, in a model monitoring or model training scenario, the first part of data may further include label data.

For example, in this embodiment of this application, a model deployment scenario may include the following scenarios:

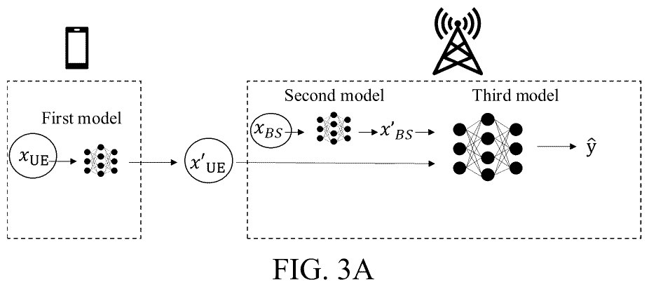

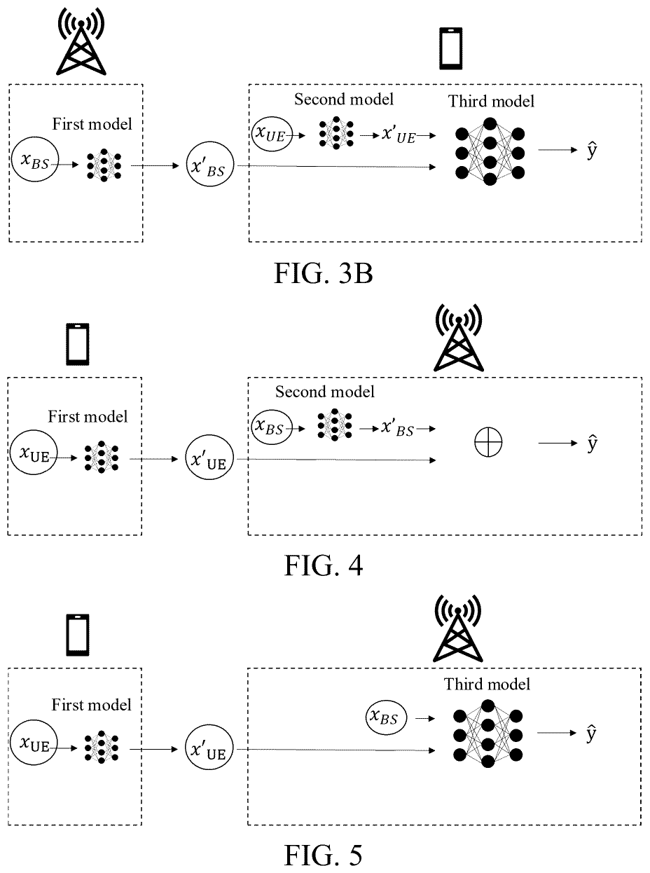

Scenario 1: As shown in FIG. 3A and FIG. 3B, a first model of a first device, a second model of a second device, and a third model of the second device are included. The third model is an AI model for performing prediction based on an output of the second model and an output of the first model, and may include a plurality of layers of neural networks. In FIG. 3A, the first device is a terminal, the second device is a base station, and the base station performs inference. In FIG. 3B, the first device is a base station, the second device is a terminal, and the terminal performs inference.

Scenario 2: As shown in FIG. 4, a third model is degraded to an addition operation. To be specific, a first model of a first device, a first model of a second device, and an addition operation of the second device are included.

Scenario 3: As shown in FIG. 5, a second model is omitted. To be specific, a first model of a first device and a third model of a second device are included.

It should be noted that, when the third model is deployed on a base station, sensitive information of the base station may be directly used as an input of the third model; or feature extraction may be performed on the sensitive information of the base station by using the second model, and then processed information is used in a model inference process. When the third model is deployed on a terminal, the first model needs to perform feature extraction on sensitive information of a base station, and then processed information is used in a model inference process. The being used in a model inference process may be understood as that the second target information and second output information are used as inputs of a subsequent third model or addition operation to obtain a final output result, for example, a prediction result.

In this embodiment of this application, the first model is set on the first device, feature extraction is performed on the sensitive information of the first device by using the first model to obtain the first output, and second information is sent to the second device based on the first output. In this way, the second device can obtain feature information to which the sensitive information of the first device is mapped, without exposing sensitive information of the second device to the first device. Therefore, integrity of data collection can be improved, to improve reliability of model training and improve accuracy of a trained model.

For example, in some embodiments, before the first device constructs the first sample dataset, the method further includes:

The first device receives the second information from the second device, where the second information includes at least one of beam requirement information and model version information, the beam requirement information is used for the first device to construct the first sample dataset, and the model version information is used for determining a version of the first model.

In this embodiment of this application, the second information may explicitly indicate at least one of the beam requirement information and the model version information, or may implicitly indicate at least one of the beam requirement information and the model version information by using a model ID and/or a function ID of a model.

For example, in some embodiments, the first target information meets any one of the following conditions:

The first target information is the first output, or the first target information is information obtained by the first device by post-processing the first output based on a post-processing configuration;
when the first model includes a first sub-model and a second sub-model, the first target information is the first output, the first output is output information of the second sub-model, an input of the first sub-model is the sensitive information of the first device or information obtained by preprocessing the sensitive information of the first device based on a preprocessing configuration, and an input of the second sub-model is output information of the first sub-model or information obtained by post-processing the output information of the first sub-model based on a post-processing configuration; or
when the first model includes a second sub-model and N sequentially connected first sub-models, the first target information is the first output, the first output is output information of the second sub-model, an input of the 1^{st} first sub-model is the sensitive information of the first device or information obtained by the first device by preprocessing the sensitive information of the first device based on a preprocessing configuration, an input of an n^{th} first sub-model is output information of an (n−1)^{th} first sub-model or information obtained by post-processing the output information of the (n−1)^{th} first sub-model based on a post-processing configuration, and an input of the second sub-model is output information of an N^{th} first sub-model or information obtained by post-processing the output information of the N^{th} first sub-model based on a post-processing configuration, where
N is an integer greater than 1; n is a positive integer less than or equal to N; the preprocessing configuration includes at least one of the following: a one-hot encoding dictionary configuration, a data normalization parameter configuration, a data regularization parameter configuration, and a data standardization parameter configuration; and the post-processing configuration includes a sparsity configuration and/or a privacy configuration.

In this embodiment of this application, in a case that a plurality of first sub-models are included, outputs of some or all of the first sub-models may be post-processed. Post-processing configurations used for post-processing output information of different first sub-models may be the same or different. This is not further limited herein.

For example, in some embodiments, the second information further includes first indication information and/or second indication information, the first indication information is used for indicating whether the second device supports the first device in performing the post-processing, and the second indication information is used for indicating the preprocessing configuration and/or the post-processing configuration.

For example, in a case that the second indication information is used for indicating the post-processing configuration, the second indication information is further used to indicate at least one firs sub-model among of the N first sub-models to which the post-processing configuration is applied.

In this embodiment of this application, that the post-processing configuration is applied to a first sub-model may be understood as that output information of the first sub-model is post-processed based on the post-processing configuration.

For example, the sparsity configuration includes at least one of the following: a quantization target precision, a quantization precision difference, and a pruning zeroing threshold.

For example, the privacy configuration includes a privacy method and a parameter configuration associated with the privacy method.

For example, the privacy method includes any one of the following: differential privacy, homomorphic encryption, and secret sharing.

For example, a parameter configuration associated with the differential privacy includes at least one of the following: a privacy mechanism and a differential privacy parameter configuration, where the differential privacy parameter configuration includes at least one of the following: a privacy budget; a relaxation term; or a clipping value or sensitivity.

For example, in a case that the first device is a terminal, before the first device constructs the first sample dataset, the method further includes:

The first device sends a first identification request message to the second device, where the first identification request message includes at least one of the following:
a version of the first model;
a version of a second model of the second device;
an output length of the first model;
output use information of the first model;
third indication information, where the third indication information is used for indicating a preprocessing configuration of the first model and/or a post-processing configuration of the first model;
a model ID of the first model;
an ID of a second model of the second device, where
the output use information includes at least one of the following: an interface between an output of the first model and a third model; or a calculation operation on an output of the second model of the second device and an output of the first model.

For example, the interface between the output of the first model and the third model may be understood as location information of the output of the first model in an input of the third model.

For example, in a case that the first device is a base station, before the first device constructs the first sample dataset, the method further includes:

The first device receives a second identification request message from the second device, where the second identification request message includes at least one of the following:
a version of the first model;
an output length of the first model;
third indication information, where the third indication information is used for indicating a preprocessing configuration of the first model and/or a post-processing configuration of the first model; or
a model ID of the first model.

For example, in some embodiments, the first information includes at least one of the following:
at least a part of the first target information;
a sample indication associated with at least a part of the first target information;
a version of the first model;
an output length of the first model; or
measured beam quality.

In this embodiment of this application, a group of target sample data may be understood as a group of complete sample data, and the at least a part of the first target information may be understood as at least a part of first target information in the group of complete sample data. For example, a group of complete sample data includes 10 pieces of first target information, and the at least a part of the first target information may be understood as some or all of the 10 pieces of first target information.

For example, the sample indication includes a single-sample indication or a multi-sample indication. The single-sample indication includes any one of the following: a sample ID, a sample collection timestamp, and a measurement resource ID.

The multi-sample indication includes any one of the following:
sample IDs of all first sample data;
sample collection timestamps of all first sample data;
a starting sample ID and a total quantity of samples;
a starting sample ID and an ending sample ID; or
a sample collection starting timestamp and a sample collection ending timestamp.

In this embodiment of this application, when the sample indication is the single-sample indication, the first information includes at least a part of first target information in a group of target sample data; or when the sample indication is the multi-sample indication, the first information includes at least a part of first target information in a plurality of groups of target sample data.

For example, the measurement resource includes at least one of a Synchronization Signal Block (SSB), a Channel State Information-Reference Signal (CSI-RS), and a Demodulation Reference Signal (DMRS).

It should be understood that the collection timestamp may be understood as time at which sensitive information of a terminal is collected or time at which first sample data is generated. For example, when performing measurement, a terminal records corresponding sensitive information to obtain first sample data.

For example, the sample collection starting timestamp may be understood as an earliest sample collection timestamp associated with the first information, and the sample collection ending timestamp may be understood as a latest sample collection timestamp associated with the first information.

For example, the method further includes:

The first device sends third information to the second device, where the third information includes first target output information, the third information is used for the second device to determine the target sample data paired with the first information, and the first target output information is the first target information determined by the first device based on an output of the first model that is associated with a mode ID, where
the first information includes a mode ID for measurement and measured beam quality, and the mode ID is used for indicating a mode corresponding to a transmit/receive beam pair, or when the first device is a base station, the mode ID is used for indicating a mode corresponding to a transmit beam of the base station.

In this embodiment of this application, before the first device sends the first information, the first device may first send the third information to the second device. The third information may include first target information associated with one or more mode IDs. In this case, when sending the first information, the first device may indicate first target information by indicating a corresponding mode ID.

For example, in some embodiments, the method further includes:

The first device sends a first target set to the second device, where the first target set is used for the second device to determine the target sample data paired with the first information, and the first target set includes first target information determined based on different first sample data and an output ID associated with the first target information, where
the first information includes a target output ID, and the target sample data includes first target information associated with the target output ID.

In this embodiment of this application, the first target set includes all first target information. For example, the first device first notifies the second device of all first outputs of the first model and output IDs associated with the first outputs, and then indicates a target output ID by using the first information; and the second device may determine currently transmitted first target information (e.g.,, a current first output of the first model) based on the target output ID.

For example, in some embodiments, the first information includes a first output ID, or a second target set and a first output ID, where
the second target set includes first target information determined based on different first sample data; and the first output ID is used for indicating first target information associated with a measurement resource.

In this embodiment of this application, the second target set may be understood as including new first target information that is different from historical first target information.
Case 1: The first information includes the first output ID and does not include the second target set. In this case, the first output ID is used for indicating historical first target information that has been transmitted by the first device.
Case 2: The first information includes the first output ID and the second target set, and a quantity of second target sets is less than a quantity of first output IDs. In this case, the second target set may further include a second output ID associated with new first target information. The second output ID is a subset of the first output ID.
Case 3: The first information includes the first output ID and the second target set, and a quantity of second target sets is equal to a quantity of first output IDs. In this case, the second target set may further include a second output ID associated with new first target information. The second output ID and the first output ID are equal, or are in a one-to-one mapping relationship.

In a case that the first device is a terminal, the first output ID is determined based on a receive beam ID corresponding to the measurement resource, or is determined based on a preprocessing indication, a post-processing indication, and a receive beam ID corresponding to the measurement resource.

In a case that the first device is a base station, the first output ID is determined based on a transmit beam ID corresponding to the measurement resource, or is determined based on a preprocessing indication, a post-processing indication, and a transmit beam ID corresponding to the measurement resource.

For example, in some embodiments, the first information may further include model version information of the first model. The third information may further include at least one of the following: an output length of the first model and version information of the first model.

For example, during model monitoring or model training data collection, the first information further includes label data.

For example, in some embodiments, the first information meets at least one of the following conditions:
the first information in one transmission includes a first part of sample data in a group of target sample data, where the first part of sample data includes at least one of the following: at least a part of the first target information and a part of information in measured beam quality; or
the first information in one transmission includes a second part of sample data in at least two groups of target sample data, where the second part of sample data includes the first target information and measured beam quality.

In this embodiment of this application, in a case that the first part of sample data includes a part of the first target information, the first target information may be aligned by using a measurement resource ID, and then first target information in a plurality of times of transmission is spliced by using a collection timestamp or sample part identification information, to obtain a complete inference sample (namely, target sample data). The sample part identification information is used for indicating a location, in the complete inference sample, of a part of first target information that is currently transmitted.

In a case that the first part of sample data includes all of the first target information, sample alignment may be performed based on a used measurement resource ID.

In a case that the first information in one transmission includes the second part of sample data in the at least two groups of target sample data, the second device needs to align the first sample data of the first device with the second sample data of the second device based on a collection timestamp or a sample ID.

It should be noted that, in a model monitoring or model training scenario, the first information in one transmission may include the second part of sample data in the at least two groups of target sample data.

For example, in some embodiments, when the first device is a terminal, the second information is carried in a channel state information CSI report configuration.

For example, when the first device is a terminal, the first information is carried in Uplink Control Information (UCI) or Radio Resource Control (RRC) signaling.

For example, in some embodiments, when the first device is a terminal and the second device is a base station, after the first device receives the second information from the second device, the method further includes:

The first device performs measurement on a configured reference signal resource, to obtain measured beam quality, where
the sensitive information of the first device is beam information and/or antenna information for measurement.

For example, in some embodiments, before the first device constructs the first sample dataset, the method further includes:

The first device obtains fourth information from a model identification device, where the fourth information is used for indicating at least one of the following:
a version of a second model of the second device;
a version of the first model;
an output length of the first model;
an interface between an output of the first model and a third model;
a calculation operation on an output of a second model of the second device and an output of the first model;
a model ID of a second model of the second device;
a model ID of the first model;
a model ID of a third model; or
third indication information, where the third indication information is used for indicating a preprocessing configuration of the first model and/or a post-processing configuration of the first model, where
the third model is an artificial intelligence AI model for performing inference and prediction based on the target sample data. For ease of understanding this application, detailed descriptions are provided below by using some examples.

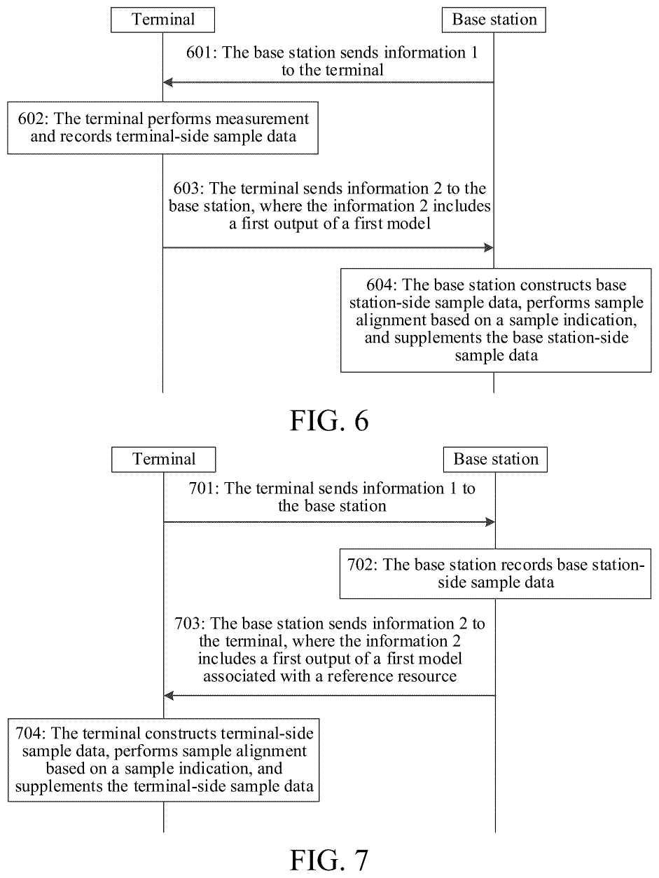

Embodiment 1: inference data collection, corresponding to the scenario in FIG. 3A. A first device is terminal, and a second device is a base station. As shown in FIG. 6, the data collection includes the following process:

Step 601: The base station sends information 1 to the terminal, where the information 1 is used for determining beam requirement information and model version information.

Step 602: The terminal performs measurement and records terminal-side sample data, where the terminal-side sample data may include receive beam information of the terminal.

Step 603: The terminal sends information 2 to the base station, where the information 2 includes a first output of a first model, and may further include measured beam quality, version information of the first model, and a sample indication.

In an inference scenario, the sample indication is a single-sample indication.

The single-sample indication may include any one of the following: a sample ID, a sample collection timestamp, and a measurement resource ID.

Step 604: The base station constructs base station-side sample data, performs sample alignment based on the sample indication, and supplements the base station-side sample data, to be specific, adds data in the information 2 to the base station-side sample data. For example, the first output of the first model, a model version of the first model, and the measured beam quality are added. For example, data associated with a same sample ID is combined to obtain target sample data. The target sample data may include the first output of the first model, the measured beam quality, the version information of the first model, an output length of the first model, and privacy information of the base station. The privacy information of the base station is used as an input of a second model or a part of input of a third model, and the first output of the first model and the measured beam quality are used as another part of input of the third model. The version information of the first model and the output length of the first model are used for verifying whether the first output of the first model is valid and available.

Embodiment 2: inference data collection, corresponding to the scenario in FIG. 3A. A first device is terminal, and a second device is a base station. A difference from Embodiment 1 lies in that, the first information exchanged in step 601 may further include a first capability and/or a first ID. The first ID is used for the terminal to determine at least one of the following configurations:
a preprocessing configuration of the first model; or
a post-processing configuration of the first model.

For example, the preprocessing configuration of the first model includes at least one of the following:
a one-hot encoding dictionary configuration;
a data normalization parameter configuration;
a data regularization parameter configuration; or
a data standardization parameter configuration, where
the one-hot encoding dictionary configuration is used for mapping data with a same physical meaning to a same one-hot code.

For example, the post-processing configuration of the first model includes a sparsity configuration and/or a privacy configuration. The sparsity configuration includes at least one of the following: a quantization target precision, a quantization precision difference, or a pruning zeroing threshold.

For example, the privacy configuration includes a privacy method and a parameter configuration. The privacy method includes differential privacy, homomorphic encryption, or secret sharing.

For example, a parameter configuration of the differential privacy includes a privacy mechanism and a differential privacy parameter configuration.

For example, the differential privacy mechanism includes but is not limited to a Laplace mechanism and a Gaussian mechanism.

For example, the differential privacy parameter configuration may include at least one of the following: a privacy budget; a relaxation term; or a clipping value or sensitivity.

For example, the first capability may be a post-processing operation of the first model that is supported by the base station, and includes at least one of the following:
supporting a sparsity operation output by the first model; or
supporting a privacy operation output by the first model.

Embodiment 3: inference data collection, corresponding to the scenario in FIG. 3B. A first device is a base station, and a second device is a terminal. As shown in FIG. 7, the data collection includes the following process:

Step 701: The terminal sends information 1 to the base station, where the information 1 is used for determining beam requirement information and model version information.

Step 702: The base station records base station-side sample data, where the base station-side sample data may include beam information of the base station.

Step 703: The base station sends information 2 to the terminal, where the information 2 includes a first output of a first model that is associated with a measurement resource, and may further include version information of the first model, an output length of the first model, and a sample indication.

In an inference scenario, the sample indication is a single-sample indication. The single-sample indication may include any one of the following: a sample ID, a sample collection timestamp, and a measurement resource ID.

Step 704: The terminal performs beam measurement based on a configured measurement resource, constructs terminal-side sample data, performs sample alignment based on the sample indication, and supplements the terminal-side sample data, to be specific, adds data in the information 2 to the terminal-side sample data. For example, the first output of the first model and a model version of the first model are added. For example, data associated with a same sample ID is combined to obtain target sample data. The target sample data includes the first output of the first model, the model version information of the first model, the output length of the first model, sensitive information of the terminal, and measured beam quality. The sensitive information of the terminal is used as an input of a second model or a part of input of a third model, and the first output of the first model and the measured beam quality are used as another part of input of the third model. The version information of the first model and the output length of the first model are used for verifying whether the first output of the first model is valid and available.

Embodiment 4: inference data collection, corresponding to the scenario in FIG. 3B. A first device is a base station, and a second device is a terminal. A difference from Embodiment 3 lies in that, the first information exchanged in step 701 may further include a first capability and/or a first ID. For a specific definition of the first capability and/or a specific definition of the first ID, refer to the foregoing Embodiment 2. Details are not described herein again.

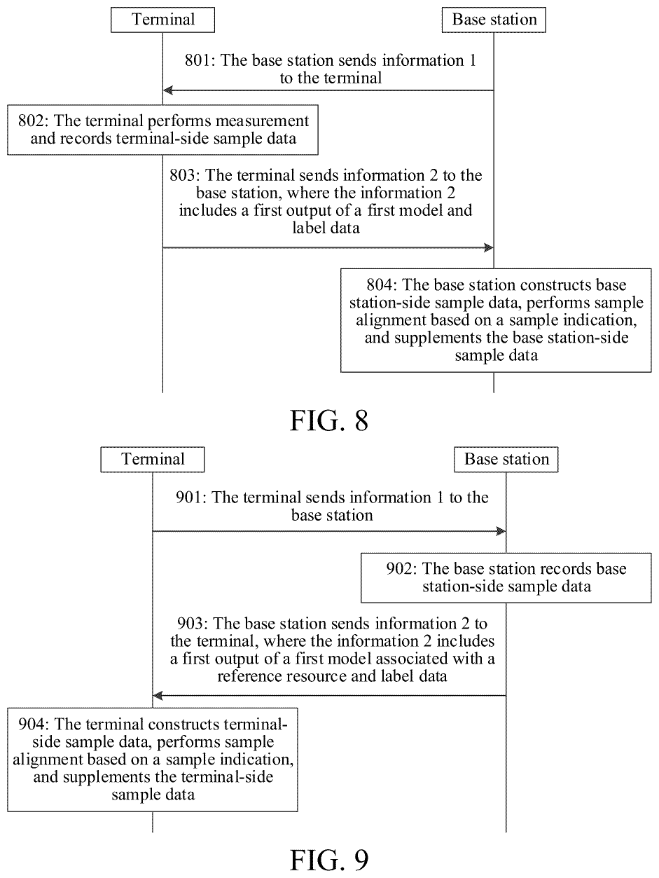

Embodiment 5: training or monitoring data collection, corresponding to the scenario in FIG. 3A. A first device is a terminal, and a second device is a base station. As shown in FIG. 8, the data collection includes the following process:

Step 801: The base station sends information 1 to the terminal, where the information 1 is used for determining beam requirement information and model version information.

Step 802: The terminal performs measurement and records terminal-side sample data, where the terminal-side sample data may include beam information of the terminal.

Step 803: The terminal sends information 2 to the base station, where the information 2 includes a first output of a first model and label data, and may further include measured beam quality, version information of the first model, and a sample indication.

For example, when the measured beam quality is a subset of the label data, a method for indicating the measured beam quality may include: a value of the measured beam quality and indication information for indicating the measured beam quality in the label data.

When the label data includes beam quality corresponding to each measurement resource, the measured beam quality may be indicated by a measurement resource set of the measured beam quality.

The sample indication may include a single-sample indication or a multi-sample indication. The single-sample indication may include any one of the following: a sample ID, a sample collection timestamp, and a measurement resource ID. The multi-sample indication includes any one of the following:
sample IDs of all samples;
sample collection timestamps of all samples;
a starting sample ID and a total quantity of samples;
a starting sample ID and an ending sample ID; or
sample collection starting timestamp and a sample collection ending timestamp.

Step 804: The base station constructs base station-side sample data, performs sample alignment based on the sample indication, and supplements the base station-side sample data, to be specific, adds data in the information 2 to the base station-side sample data. For example, the first output of the first model, a model version of the first model, and the measured beam quality are added. For example, data associated with a same sample ID is combined to obtain target sample data. The target sample data may include the first output of the first model, the measured beam quality, the label data, the version information of the first model, an output length of the first model, and privacy information of the base station. Input data of a training sample of the second device includes the privacy information of the base station, the first output of the first model, and the measured beam quality. The version information of the first model is used for indicating a training progress, and the output length of the first model are used for verifying whether the first output of the first model is valid and available. It should be noted that an output of the first model may include terminal beam information corresponding to one measurement beam, or a plurality of pieces of terminal beam information corresponding to a plurality of measurement beams.

For example, data of a plurality of terminals belonging to a same user group may be aggregated to form a training sample for training.

For example, data of a plurality of base stations belonging to a same user group may be aggregated to form a training sample for training.

Determining of a same user group may include at least one of the following:
whether devices belong to a same device manufacturer;
whether devices belong to a same terminal manufacturer;
whether devices belong to a same terminal model of a same terminal manufacturer;
whether devices belong to a same chip manufacturer; or
whether devices belong to a same antenna architecture.

Embodiment 6: training or monitoring data collection, corresponding to the scenario in FIG. 3B. A first device is a base station, and a second device is a terminal. As shown in FIG. 9, the data collection includes the following process:

Step 901: The terminal sends information 1 to the base station, where the information 1 is used for determining beam requirement information and model version information.

Step 902: The base station records base station-side sample data, where the base station-side sample data may include beam information and/or antenna information of the base station.

Step 903: The base station sends information 2 to the terminal, where the information 2 includes a first output of a first model and label data, and may further include version information of the first model and a sample indication.

The sample indication may include a single-sample indication or a multi-sample indication. The single-sample indication may include any one of the following: a sample ID, a sample collection timestamp, and a measurement resource ID. The multi-sample indication includes any one of the following:
sample IDs of all samples;
sample collection timestamps of all samples;
a starting sample ID and a total quantity of samples;
a starting sample ID and an ending sample ID; or
a sample collection starting timestamp and a sample collection ending timestamp.

Step 904: The terminal performs beam measurement based on a configured measurement resource, constructs terminal-side sample data, performs sample alignment based on the sample indication, and supplements the terminal-side sample data, to be specific, adds data in the information 2 to the terminal-side sample data. For example, the first output of the first model and a model version of the first model are added. For example, data associated with a same sample ID is combined to obtain target sample data. The target sample data may include the first output of the first model, the measured beam quality, the label data, the version information of the first model, an output length of the first model, and privacy information of the terminal. Input data of a training sample of the second device includes the privacy information of the terminal, the first output of the first model, and the measured beam quality. The version information of the first model is used for indicating a training progress, and the output length of the first model are used for verifying whether the first output of the first model is valid and available.

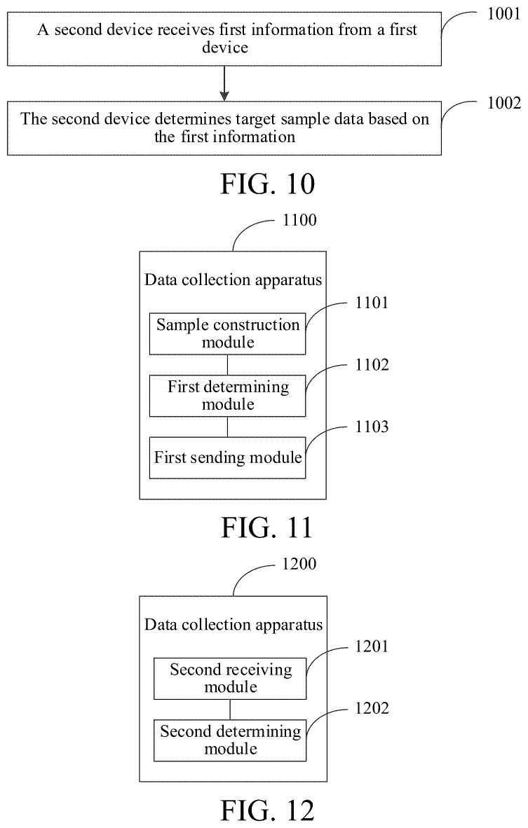

With reference to FIG. 10, an embodiment of this application further provides a data collection method. As shown in FIG. 10, the data collection method includes the following steps:

Step 1001: A second device receives first information from a first device, where the first information is determined based on a first output of a first model, an input of the first model is determined based on a first sample dataset, and first sample data in the first sample dataset includes sensitive information of the first device.

Step 1002: The second device determines target sample data based on the first information.

A group of target sample data includes first target information and second target information. The first target information is information determined based on a first output corresponding to the first sample data. The second target information is determined based on second sample data. The second sample data includes sensitive information of the second device.

For example, before the second device receives the first information from the first device, the method further includes:

The second device sends second information to the first device, where the second information includes at least one of beam requirement information and model version information, the beam requirement information is used for the first device to construct the first sample dataset, and the model version information is used for determining a version of the first model.

For example, the first target information meets any one of the following conditions:

The first target information is the first output, or the first target information is information obtained by the first device by post-processing the first output based on a post-processing configuration;
in a case that the first model includes a first sub-model and a second sub-model, the first target information is the first output, the first output is output information of the second sub-model, an input of the first sub-model is the sensitive information of the first device or information obtained by preprocessing the sensitive information of the first device based on a preprocessing configuration, and an input of the second sub-model is output information of the first sub-model or information obtained by post-processing the output information of the first sub-model based on a post-processing configuration; or
in a case that the first model includes a second sub-model and N sequentially connected first sub-models, the first target information is the first output, the first output is output information of the second sub-model, an input of the 1^{st} first sub-model is the sensitive information of the first device or information obtained by the first device by preprocessing the sensitive information of the first device based on a preprocessing configuration, an input of an n^{th} first sub-model is output information of an (n−1)^{th} first sub-model or information obtained by post-processing the output information of the (n−1)^{th} first sub-model based on a post-processing configuration, and an input of the second sub-model is output information of an N^{th} first sub-model or information obtained by post-processing the output information of the N^{th} first sub-model based on a post-processing configuration, where
N is an integer greater than 1; n is a positive integer less than or equal to N; the preprocessing configuration includes at least one of the following: a one-hot encoding dictionary configuration, a data normalization parameter configuration, a data regularization parameter configuration, and a data standardization parameter configuration; and the post-processing configuration includes a sparsity configuration and/or a privacy configuration.

For example, the second information further includes first indication information and/or second indication information, the first indication information is used for indicating whether the second device supports the first device in performing the post-processing, and the second indication information is used for indicating the preprocessing configuration and/or the post-processing configuration.

For example, in a case that the second indication information is used for indicating the post-processing configuration, the second indication information is further used to indicate at least one first sub-model of the N first sub-models to which the post-processing configuration is applied.

For example, the second target information meets any one of the following conditions:
the second target information is the second sample data;
the second target information is a second output of a second model, or the second target information is information obtained by the second device by post-processing the second output based on a post-processing configuration;
in a case that the second model includes a third sub-model and a fourth sub-model, the second target information is the second output, the second output is output information of the fourth sub-model, an input of the third sub-model is the sensitive information of the second device or information obtained by preprocessing the sensitive information of the second device based on a preprocessing configuration, and an input of the fourth sub-model is output information of the third sub-model or information obtained by post-processing the output information of the third sub-model based on a post-processing configuration; or
in a case that the second model includes a fourth sub-model and M sequentially connected third sub-models, the second target information is the second output of the second model, the second output is output information of the fourth sub-model, an input of the 1^{st} third sub-model is the sensitive information of the second device or information obtained by the second device by preprocessing the sensitive information of the second device based on a preprocessing configuration, an input of an m^{th} third sub-model is output information of an (m−1)^{th} third sub-model or information obtained by post-processing the output information of the (m−1)^{th} third sub-model based on a post-processing configuration, and an input of the fourth sub-model is output information of an M^{th} third sub-model or information obtained by post-processing the output information of the M^{th} third sub-model based on a post-processing configuration, where M is an integer greater than 1; m is a positive integer less than or equal to M; the preprocessing configuration includes at least one of the following: a one-hot encoding dictionary configuration, a data normalization parameter configuration, a data regularization parameter configuration, and a data standardization parameter configuration; and the post-processing configuration includes a sparsity configuration and/or a privacy configuration.

For example, the sparsity configuration includes at least one of the following: a quantization target precision, a quantization precision difference, and a pruning zeroing threshold.

For example, the privacy configuration includes a privacy method and a parameter configuration associated with the privacy method.

For example, the privacy method includes any one of the following: differential privacy, homomorphic encryption, and secret sharing.

For example, a parameter configuration associated with the differential privacy includes at least one of the following: a privacy mechanism and a differential privacy parameter configuration, where the differential privacy parameter configuration includes at least one of the following: a privacy budget; a relaxation term; or a clipping value or sensitivity.

For example, in a case that the second device is a base station, before the second device receives the first information from the first device, the method further includes:

The second device receives a first identification request message from the first device, where the first identification request message includes at least one of the following:
a version of the first model;
a version of a second model of the second device;
an output length of the first model;
output use information of the first model;
third indication information, where the third indication information is used for indicating a preprocessing configuration of the first model and/or a post-processing configuration of the first model;
a model ID of the first model; or
an ID of a second model of the second device, where
the output use information includes at least one of the following: an interface between an output of the first model and a third model; or a calculation operation on an output of the second model of the second device and an output of the first model.

For example, in a case that the second device is a terminal, before the second device receives the first information from the first device, the method further includes:

The second device sends a second identification request message to the first device, where the second identification request message includes at least one of the following:
a version of the first model;
an output length of the first model;
third indication information, where the third indication information is used for indicating a preprocessing configuration of the first model and/or a post-processing configuration of the first model; or
a model ID of the first model.

For example, the first information includes at least one of the following:
at least a part of the first target information;
a sample indication associated with at least a part of the first target information;
a version of the first model;
an output length of the first model; or
measured beam quality.

For example, the sample indication includes a single-sample indication or a multi-sample indication. The single-sample indication includes any one of the following: a sample ID, a sample collection timestamp, and a measurement resource ID.

The multi-sample indication includes any one of the following:
sample IDs of all first sample data;
collection timestamps of all first sample data;
a starting sample ID and a total quantity of samples;
a starting sample ID and an ending sample ID; or
a sample collection starting timestamp and a sample collection ending timestamp.

For example, the method further includes:

The second device receives third information from the first device, where the third information includes first target output information, the third information is used for the second device to determine the target sample data paired with the first information, and the first target output information is the first target information determined by the first device based on an output of the first model that is associated with a mode ID, where
the first information includes a mode ID for measurement and measured beam quality, and the mode ID is used for indicating a mode corresponding to a transmit/receive beam pair, or when the first device is a base station, the mode ID is used for indicating a mode corresponding to a transmit beam of the base station.

For example, during model monitoring or model training data collection, the first information further includes label data.

For example, the method further includes:

The second device receives a first target set from the first device, where the first target set is used for the second device to determine the target sample data paired with the first information, and the first target set includes first target information determined based on different first sample data and an output ID associated with the first target information, where
the first information includes a target output ID, and the target sample data includes first target information associated with the target output ID.

For example, the first information includes a first output ID, or a second target set and a first output ID, where
the second target set includes first target information determined based on different first sample data; and the first output ID is used for indicating first target information associated with a measurement resource.

For example, the first information meets at least one of the following conditions:
the first information in one transmission includes a first part of sample data in a group of target sample data, where the first part of sample data includes at least one of the following: at least a part of the first target information and a part of information in the measured beam quality; or the first information in one transmission includes a second part of sample data in at least two groups of target sample data, where the second part of sample data includes the first target information and the measured beam quality.

For example, when the first device is a terminal, the second information is carried in a channel state information CSI report configuration.

For example, when the first device is a terminal, the first information is carried in uplink control information UCI or radio resource control RRC signaling.

For example, before the second device sends the second information to the first device, the method further includes:

The second device obtains fifth information from a model identification device, where the fifth information is used for indicating at least one of the following: a version of the first model; a version of a second model of the second device;
an output length of the first model;
an interface between an output of the first model and a third model;
an interface between an output of a second model of the second device and a third model;
a calculation operation on an output of the first model and an output of a second model of the second device;
a model ID of the first model;
a model ID of a second model of the second device;
a model ID of a third model;
third indication information, where the third indication information is used for indicating a preprocessing configuration of the first model and/or a post-processing configuration of the first model; or
fourth indication information, where the fourth indication information is used for indicating a preprocessing configuration of the second model and/or a post-processing configuration of the second model, where
the third model is an artificial intelligence AI model for performing inference and prediction based on the target sample data.

In this embodiment of this application, the first model is set on the first device, feature extraction is performed on the sensitive information of the first device by using the first model to obtain the first output, and second information is sent to the second device based on the first output. In this way, the second device can obtain the sensitive information of the first device without exposing sensitive information of the second device. Therefore, integrity of data collection can be improved, to improve reliability of model training and improve accuracy of a trained model.

The data collection method provided in the embodiments of this application may be performed by a data collection apparatus. In the embodiments of this application, a data collection apparatus provided in the embodiments of this application is described by using an example in which the data collection apparatus performs the data collection method.

With reference to FIG. 11, an embodiment of this application further provides a data collection apparatus. As shown in FIG. 11, the data collection apparatus 1100 includes:
a sample construction module 1101, configured to construct a first sample dataset, where first sample data in the first sample dataset includes sensitive information of a first device;
a first determining module 1102, configured to determine a first output of a first model based on the first sample dataset, where the first model is used for performing feature extraction on the sensitive information of the first device; and
a first sending module 1103, configured to send first information to a second device, where the first information is determined based on the first output of the first model, and the first information is used for the second device to determine target sample data, where
a group of target sample data includes first target information and second target information, the first target information is information determined based on a first output corresponding to the first sample data, the second target information is determined based on second sample data, and the second sample data includes sensitive information of the second device.

For example, the data collection apparatus 1100 further includes:
a first receiving module, configured to receive second information from the second device, where the second information includes at least one of beam requirement information and model version information, the beam requirement information is used for the first device to construct the first sample dataset, and the model version information is used for determining a version of the first model.

For example, the first target information meets any one of the following conditions:
the first target information is the first output, or the first target information is information obtained by the first device by post-processing the first output based on a post-processing configuration; in a case that the first model includes a first sub-model and a second sub-model, the first target information is the first output, the first output is output information of the second sub-model, an input of the first sub-model is the sensitive information of the first device or information obtained by preprocessing the sensitive information of the first device based on a preprocessing configuration, and an input of the second sub-model is output information of the first sub-model or information obtained by post-processing the output information of the first sub-model based on a post-processing configuration; or
in a case that the first model includes a second sub-model and N sequentially connected first sub-models, the first target information is the first output, the first output is output information of the second sub-model, an input of the 1^{st} first sub-model is the sensitive information of the first device or information obtained by the first device by preprocessing the sensitive information of the first device based on a preprocessing configuration, an input of an n^{th} first sub-model is output information of an (n−1)^{th} first sub-model or information obtained by post-processing the output information of the (n−1)^{th} first sub-model based on a post-processing configuration, and an input of the second sub-model is output information of an N^{th} first sub-model or information obtained by post-processing the output information of the N^{th} first sub-model based on a post-processing configuration, where
N is an integer greater than 1; n is a positive integer less than or equal to N; the preprocessing configuration includes at least one of the following: a one-hot encoding dictionary configuration, a data normalization parameter configuration, a data regularization parameter configuration, and a data standardization parameter configuration; and the post-processing configuration includes a sparsity configuration and/or a privacy configuration.

For example, the second information further includes first indication information and/or second indication information, the first indication information is used for indicating whether the second device supports the first device in performing the post-processing, and the second indication information is used for indicating the preprocessing configuration and/or the post-processing configuration.

For example, in a case that the second indication information is used for indicating the post-processing configuration, the second indication information is further used to indicate at least one firs sub-model among of the N first sub-models to which the post-processing configuration is applied.

For example, the sparsity configuration includes at least one of the following: a quantization target precision, a quantization precision difference, and a pruning zeroing threshold.

For example, the privacy configuration includes a privacy method and a parameter configuration associated with the privacy method.

For example, the privacy method includes any one of the following: differential privacy, homomorphic encryption, and secret sharing.

For example, a parameter configuration associated with the differential privacy includes at least one of the following: a privacy mechanism and a differential privacy parameter configuration, where the differential privacy parameter configuration includes at least one of the following: a privacy budget; a relaxation term; or a clipping value or sensitivity.

For example, in a case that the first device is a terminal, the first sending module 1103 is further configured to send a first identification request message to the second device, where the first identification request message includes at least one of the following:
a version of the first model;
a version of a second model of the second device;
an output length of the first model;
output use information of the first model;
third indication information, where the third indication information is used for indicating a preprocessing configuration of the first model and/or a post-processing configuration of the first model;
a model ID of the first model; or
an ID of the second model of the second device, where
the output use information includes at least one of the following: an interface between an output of the first model and a third model; or a calculation operation on an output of the second model of the second device and an output of the first model.

For example, in a case that the first device is a base station, the data collection apparatus 1100 further includes:
a first receiving module, configured to receive a second identification request message from the second device, where the second identification request message includes at least one of the following:
a version of the first model;
an output length of the first model;
third indication information, where the third indication information is used for indicating a preprocessing configuration of the first model and/or a post-processing configuration of the first model; or
a model ID of the first model.

For example, the first information includes at least one of the following:
at least a part of the first target information;
a sample indication associated with at least a part of the first target information;
a version of the first model;
an output length of the first model; or
measured beam quality.

For example, the sample indication includes a single-sample indication or a multi-sample indication. The single-sample indication includes any one of the following: a sample ID, a sample collection timestamp, and a measurement resource ID.

The multi-sample indication includes any one of the following:
sample IDs of all first sample data;
sample collection timestamps of all first sample data;
a starting sample ID and a total quantity of samples;
a starting sample ID and an ending sample ID; or
a sample collection starting timestamp and a sample collection ending timestamp.

For example, the first sending module 1103 is further configured to send third information to the second device, where the third information includes first target output information, the third information is used for the second device to determine the target sample data paired with the first information, and the first target output information is the first target information determined by the first device based on an output of the first model that is associated with a mode ID, where the first information includes a mode ID for measurement and measured beam quality, and the mode ID is used for indicating a mode corresponding to a transmit/receive beam pair, or when the first device is a base station, the mode ID is used for indicating a mode corresponding to a transmit beam of the base station.

For example, during model monitoring or model training data collection, the first information further includes label data.

For example, the first sending module 1103 is further configured to send a first target set to the second device, where the first target set is used for the second device to determine the target sample data paired with the first information, and the first target set includes first target information determined based on different first sample data and an output ID associated with the first target information, where
the first information includes a target output ID, and the target sample data includes first target information associated with the target output ID.

For example, the first information includes a first output ID, or a second target set and a first output ID, where
the second target set includes first target information determined based on different first sample data; and the first output ID is used for indicating first target information associated with a measurement resource.

For example, the first information meets at least one of the following conditions:

the first information in one transmission includes a first part of sample data in a group of target sample data, where the first part of sample data includes at least one of the following: at least a part of the first target information and a part of information in measured beam quality; or the first information in one transmission includes a second part of sample data in at least two groups of target sample data, where the second part of sample data includes the first target information and measured beam quality.

For example, when the first device is a terminal, the second information is carried in a channel state information CSI report configuration.

For example, when the first device is a terminal, the first information is carried in uplink control information UCI or radio resource control RRC signaling.

For example, when the first device is a terminal and the second device is a base station, after the first device receives the second information from the second device, the method further includes:

The first device performs measurement on a configured reference signal resource, to obtain measured beam quality, where
the sensitive information of the first device is beam information and/or antenna information for measurement.

For example, before the first device constructs the first sample dataset, the method further includes:

The first device obtains fourth information from a model identification device, where the fourth information is used for indicating at least one of the following:
a version of a second model of the second device;
a version of the first model;
an output length of the first model;
an interface between an output of the first model and a third model;
a calculation operation on an output of a second model of the second device and an output of the first model;
a model ID of a second model of the second device;
a model ID of the first model;
a model ID of a third model; or
third indication information, where the third indication information is used for indicating a preprocessing configuration of the first model and/or a post-processing configuration of the first model, where
the third model is an artificial intelligence AI model for performing inference and prediction based on the target sample data.

With reference to FIG. 12, an embodiment of this application further provides a data collection apparatus 1200. As shown in FIG. 12, the data collection apparatus 1200 includes: a second receiving module 1201, configured to receive first information from a first device, where the first information is determined based on a first output of a first model, an input of the first model is determined based on a first sample dataset, and first sample data in the first sample dataset includes sensitive information of the first device; and
a second determining module 1202, configured to determine target sample data based on the first information, where
a group of target sample data includes first target information and second target information, the first target information is information determined based on a first output corresponding to the first sample data, the second target information is determined based on second sample data, and the second sample data includes sensitive information of the second device.

For example, the data collection apparatus 1200 further includes:
a second sending module, configured to send second information to the first device, where the second information includes at least one of beam requirement information and model version information, the beam requirement information is used for the first device to construct the first sample dataset, and the model version information is used for determining a version of the first model.

For example, the first target information meets any one of the following conditions:
the first target information is the first output, or the first target information is information obtained by the first device by post-processing the first output based on a post-processing configuration; in a case that the first model includes a first sub-model and a second sub-model, the first target information is the first output, the first output is output information of the second sub-model, an input of the first sub-model is the sensitive information of the first device or information obtained by preprocessing the sensitive information of the first device based on a preprocessing configuration, and an input of the second sub-model is output information of the first sub-model or information obtained by post-processing the output information of the first sub-model based on a post-processing configuration; or
in a case that the first model includes a second sub-model and N sequentially connected first sub-models, the first target information is the first output, the first output is output information of the second sub-model, an input of the 1^{st} first sub-model is the sensitive information of the first device or information obtained by the first device by preprocessing the sensitive information of the first device based on a preprocessing configuration, an input of an n^{th} first sub-model is output information of an (n−1)^{th} first sub-model or information obtained by post-processing the output information of the (n−1)^{th} first sub-model based on a post-processing configuration, and an input of the second sub-model is output information of an N^{th} first sub-model or information obtained by post-processing the output information of the N^{th} first sub-model based on a post-processing configuration, where
N is an integer greater than 1; n is a positive integer less than or equal to N; the preprocessing configuration includes at least one of the following: a one-hot encoding dictionary configuration, a data normalization parameter configuration, a data regularization parameter configuration, and a data standardization parameter configuration; and the post-processing configuration includes a sparsity configuration and/or a privacy configuration.

For example, the second information further includes first indication information and/or second indication information, the first indication information is used for indicating whether the second device supports the first device in performing the post-processing, and the second indication information is used for indicating the preprocessing configuration and/or the post-processing configuration.

For example, in a case that the second indication information is used for indicating the post-processing configuration, the second indication information is further used to indicate at least one firs sub-model among of the N first sub-models to which the post-processing configuration is applied.

For example, the second target information meets any one of the following conditions:
the second target information is the second sample data;
the second target information is a second output of a second model, or the second target information is information obtained by the second device by post-processing the second output based on a post-processing configuration;
in a case that the second model includes a third sub-model and a fourth sub-model, the second target information is the second output, the second output is output information of the fourth sub-model, an input of the third sub-model is the sensitive information of the second device or information obtained by preprocessing the sensitive information of the second device based on a preprocessing configuration, and an input of the fourth sub-model is output information of the third sub-model or information obtained by post-processing the output information of the third sub-model based on a post-processing configuration; or
in a case that the second model includes a fourth sub-model and M sequentially connected third sub-models, the second target information is the second output of the second model, the second output is output information of the fourth sub-model, an input of the 1^{st} third sub-model is the sensitive information of the second device or information obtained by the second device by preprocessing the sensitive information of the second device based on a preprocessing configuration, an input of an m^{th} third sub-model is output information of an (m−1)^{th} third sub-model or information obtained by post-processing the output information of the (m−1)^{th} third sub-model based on a post-processing configuration, and an input of the fourth sub-model is output information of an M^{th} third sub-model or information obtained by post-processing the output information of the M^{th} third sub-model based on a post-processing configuration, where M is an integer greater than 1; m is a positive integer less than or equal to M; the preprocessing configuration includes at least one of the following: a one-hot encoding dictionary configuration, a data normalization parameter configuration, a data regularization parameter configuration, and a data standardization parameter configuration; and the post-processing configuration includes a sparsity configuration and/or a privacy configuration.

For example, the sparsity configuration includes at least one of the following: a quantization target precision, a quantization precision difference, and a pruning zeroing threshold.

For example, the privacy configuration includes a privacy method and a parameter configuration associated with the privacy method.

For example, the privacy method includes any one of the following: differential privacy, homomorphic encryption, and secret sharing.

For example, a parameter configuration associated with the differential privacy includes at least one of the following: a privacy mechanism and a differential privacy parameter configuration, where the differential privacy parameter configuration includes at least one of the following: a privacy budget; a relaxation term; or a clipping value or sensitivity.

For example, in a case that the second device is a base station, the second receiving module 1201 is further configured to receive a first identification request message from the first device, where the first identification request message includes at least one of the following:
a version of the first model;
a version of a second model of the second device;
an output length of the first model;
output use information of the first model;
third indication information, where the third indication information is used for indicating a preprocessing configuration of the first model and/or a post-processing configuration of the first model;
a model ID of the first model; or
an ID of the second model of the second device, where
the output use information includes at least one of the following: an interface between an output of the first model and a third model; or a calculation operation on an output of the second model of the second device and an output of the first model.

For example, in a case that the second device is a terminal, the data collection apparatus 1200 further includes:
a second sending module, configured to send a second identification request message to the first device, where the second identification request message includes at least one of the following:
a version of the first model;
an output length of the first model;
third indication information, where the third indication information is used for indicating a preprocessing configuration of the first model and/or a post-processing configuration of the first model; or
a model ID of the first model.

For example, the first information includes at least one of the following:
at least a part of the first target information;
a sample indication associated with at least a part of the first target information;
a version of the first model;
an output length of the first model; or
measured beam quality.

For example, the sample indication includes a single-sample indication or a multi-sample indication. The single-sample indication includes any one of the following: a sample ID, a sample collection timestamp, and a measurement resource ID.

The multi-sample indication includes any one of the following:
sample IDs of all first sample data;
collection timestamps of all first sample data;
a starting sample ID and a total quantity of samples;
a starting sample ID and an ending sample ID; or
a sample collection starting timestamp and a sample collection ending timestamp.

For example, the second receiving module 1201 is further configured to receive third information from the first device, where the third information includes first target output information, the third information is used for the second device to determine the target sample data paired with the first information, and the first target output information is the first target information determined by the first device based on an output of the first model that is associated with a mode ID, where
the first information includes a mode ID for measurement and measured beam quality, and the mode ID is used for indicating a mode corresponding to a transmit/receive beam pair, or when the first device is a base station, the mode ID is used for indicating a mode corresponding to a transmit beam of the base station.

For example, during model monitoring or model training data collection, the first information further includes label data.

For example, the second receiving module 1201 is further configured to receive a first target set from the first device, where the first target set is used for the second device to determine the target sample data paired with the first information, and the first target set includes first target information determined based on different first sample data and an output ID associated with the first target information, where
the first information includes a target output ID, and the target sample data includes first target information associated with the target output ID.

For example, the first information includes a first output ID, or a second target set and a first output ID, where
the second target set includes first target information determined based on different first sample data; and the first output ID is used for indicating first target information associated with a measurement resource.

For example, the first information meets at least one of the following conditions:
the first information in one transmission includes a first part of sample data in a group of target sample data, where the first part of sample data includes at least one of the following: at least a part of the first target information and a part of information in the measured beam quality; or the first information in one transmission includes a second part of sample data in at least two groups of target sample data, where the second part of sample data includes the first target information and the measured beam quality.

For example, when the first device is a terminal, the second information is carried in a channel state information CSI report configuration.

For example, when the first device is a terminal, the first information is carried in uplink control information UCI or radio resource control RRC signaling.

For example, in a case that the second device is a base station, before the second device receives the first information from the first device, the method further includes:

The second device obtains fifth information from a model identification device, where the fifth information is used for indicating at least one of the following: a version of the first model;
a version of a second model of the second device;
an output length of the first model;
an interface between an output of the first model and a third model;
an interface between an output of a second model of the second device and a third model;
a calculation operation on an output of the first model and an output of a second model of the second device;
a model ID of the first model;
a model ID of a second model of the second device;
a model ID of a third model;
third indication information, where the third indication information is used for indicating a preprocessing configuration of the first model and/or a post-processing configuration of the first model; or
fourth indication information, where the fourth indication information is used for indicating a preprocessing configuration of the second model and/or a post-processing configuration of the second model, where
the third model is an artificial intelligence AI model for performing inference and prediction based on the target sample data.

The data collection apparatus in this embodiment of this application may be an electronic device, for example, an electronic device with an operating system; or may be a component in an electronic device, for example, an integrated circuit or a chip. The electronic device may be a terminal or another device other than the terminal. For example, the terminal may include but is not limited to the aforementioned types of the terminal 11, and the another device may be a server, a Network Attached Storage (NAS), or the like. This is not limited in this embodiment of this application.

The data collection apparatus provided in this embodiment of this application is capable of implementing the processes implemented in the method embodiments of FIG. 2 to FIG. 10, with the same technical effect achieved. To avoid repetition, details are not described herein again.

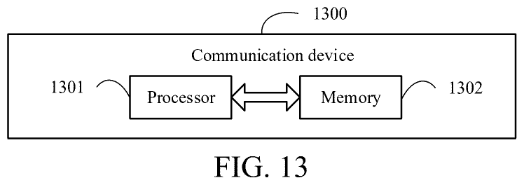

For example, as shown in FIG. 13, an embodiment of this application further provides a communication device 1300, including a processor 1301 and a memory 1302. The memory 1302 stores a program or instructions capable of running on the processor 1301. When the program or the instructions is/are executed by the processor 1301, the steps in the embodiments of the data collection method are implemented, with the same technical effect achieved. To avoid repetition, details are not described herein again.

An embodiment of this application further provides a terminal, including a processor and a communication interface.

When the terminal is a first device, the processor is configured to: construct first sample dataset, where first sample data in the first sample dataset includes sensitive information of the first device; and determine a first output of a first model based on the first sample dataset, where the first model is used for performing feature extraction on the sensitive information of the first device; and
the communication interface is configured to send first information to a second device, where the first information is determined based on the first output of the first model, and the first information is used for the second device to determine target sample data, where
a group of target sample data includes first target information and second target information, the first target information is information determined based on a first output corresponding to the first sample data, the second target information is determined based on second sample data, and the second sample data includes sensitive information of the second device.

When the terminal is a second device, the communication interface is configured to receive first information from a first device, where the first information is determined based on a first output of a first model, an input of the first model is determined based on a first sample dataset, and first sample data in the first sample dataset includes sensitive information of the first device; and
the processor is configured to determine target sample data based on the first information, where a group of target sample data includes first target information and second target information, the first target information is information determined based on a first output corresponding to the first sample data, the second target information is determined based on second sample data, and the second sample data includes sensitive information of the second device.

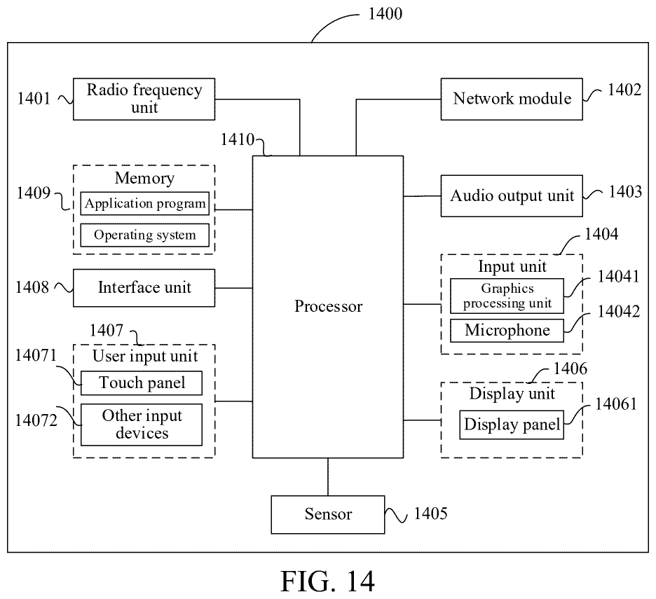

The terminal embodiment corresponds to the foregoing terminal-side method embodiment, and all implementation processes and implementations of the foregoing method embodiment are applicable to the terminal embodiment, with the same technical effect achieved. For example, FIG. 14 is a schematic diagram of a hardware structure of a terminal for implementing the embodiments of this application.

The terminal 1400 includes but is not limited to at least some of the following components: a radio frequency unit 1401, a network module 1402, an audio output unit 1403, an input unit 1404, a sensor 1405, a display unit 1406, a user input unit 1407, an interface unit 1408, a memory 1409, a processor 1410, and the like.

It is understood that the terminal 1400 may further include a power supply (for example, a battery) that supplies power to each component. The power supply may be logically connected to the processor 1410 through a power management system, so that functions such as charging management, discharging management, and power consumption management are implemented through the power management system. The terminal structure shown in FIG. 14 does not constitute a limitation on the terminal. The terminal may include more or fewer components than those shown in the figure, or some components may be combined, or different component arrangements may be used. Details are not described herein again.

It should be understood that, in this embodiment of this application, the input unit 1404 may include a Graphics Processing Unit (GPU) 14041 and a microphone 14042. The graphics processing unit 14041 processes image data of a static picture or a video that is obtained by an image capture apparatus (for example, a camera) in a video capture mode or an image capture mode. The display unit 1406 may include a display panel 14061. The display panel 14061 may be configured in a form of a liquid crystal display, an organic light-emitting diode, or the like. The user input unit 1407 includes at least one of a touch panel 14071 and other input devices 14072. The touch panel 14071 is also referred to as a touchscreen. The touch panel 14071 may include two parts: a touch detection apparatus and a touch controller. The other input devices 14072 may include but are not limited to a physical keyboard, a function button (such as a volume control button or an on/off button), a trackball, a mouse, and a joystick. Details are not described herein.

In this embodiment of this application, after receiving downlink data from a network-side device, the radio frequency unit 1401 may transmit the downlink data to the processor 1410 for processing. In addition, the radio frequency unit 1401 may transmit uplink data to the network-side device. Usually, the radio frequency unit 1401 includes but is not limited to an antenna, an amplifier, a transceiver, a coupler, a low noise amplifier, a duplexer, and the like.

The memory 1409 may be configured to store software programs or instructions and various data. The memory 1409 may mainly include a first storage region for storing a program or instructions and a second storage region for storing data. The first storage region may store an operating system, an application or instructions required by at least one function (for example, an audio play function or an image play function), and the like. In addition, the memory 1409 may include a volatile memory or a non-volatile memory, or the memory 1409 may include both a volatile memory and a non-volatile memory. The non-volatile memory may be a Read-Only Memory (ROM), a programmable read-only memory (PROM), an erasable programmable read-only memory (EPROM), an electrically erasable programmable read-only memory (EEPROM), or a flash memory. The volatile memory may be a Random Access Memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), or a direct rambus random access memory (DRRAM). The memory 1409 in this embodiment of this application includes but is not limited to these and any other suitable types of memories.

The processor 1410 may include one or more processing units. For example, the processor 1410 integrates an application processor and a modem processor. The application processor mainly processes operations related to an operating system, a user interface, an application, and the like. The modem processor mainly processes wireless communication signals, for example, is a baseband processor. It can be understood that the modem processor may, for example, not be integrated in the processor 1410.

When the terminal is a first device, the processor 1410 is configured to: construct first sample dataset, where first sample data in the first sample dataset includes sensitive information of the first device; and determine a first output of a first model based on the first sample dataset, where the first model is used for performing feature extraction on the sensitive information of the first device; and
the radio frequency unit 1401 is configured to send first information to a second device, where the first information is determined based on the first output of the first model, and the first information is used for the second device to determine target sample data, where
a group of target sample data includes first target information and second target information, the first target information is information determined based on a first output corresponding to the first sample data, the second target information is determined based on second sample data, and the second sample data includes sensitive information of the second device.

When the terminal is a second device, the radio frequency unit 1401 is configured to receive first information from a first device, where the first information is determined based on a first output of a first model, an input of the first model is determined based on a first sample dataset, and first sample data in the first sample dataset includes sensitive information of the first device; and
the processor 1410 is configured to determine target sample data based on the first information, where
a group of target sample data includes first target information and second target information, the first target information is information determined based on a first output corresponding to the first sample data, the second target information is determined based on second sample data, and the second sample data includes sensitive information of the second device.

An embodiment of this application further provides a network-side device, including a processor and a communication interface.

When the network-side device is a first device, the processor is configured to: construct first sample dataset, where first sample data in the first sample dataset includes sensitive information of the first device; and determine a first output of a first model based on the first sample dataset, where the first model is used for performing feature extraction on the sensitive information of the first device; and
the communication interface is configured to send first information to a second device, where the first information is determined based on the first output of the first model, and the first information is used for the second device to determine target sample data, where
a group of target sample data includes first target information and second target information, the first target information is information determined based on a first output corresponding to the first sample data, the second target information is determined based on second sample data, and the second sample data includes sensitive information of the second device.

When the network-side device is a second device, the communication interface is configured to receive first information from a first device, where the first information is determined based on a first output of a first model, an input of the first model is determined based on a first sample dataset, and first sample data in the first sample dataset includes sensitive information of the first device; and
the processor is configured to determine target sample data based on the first information, where a group of target sample data includes first target information and second target information, the first target information is information determined based on a first output corresponding to the first sample data, the second target information is determined based on second sample data, and the second sample data includes sensitive information of the second device.

The network-side device embodiment corresponds to the foregoing method embodiment for the network-side device, and all implementation processes and implementations of the foregoing method embodiment are applicable to the network-side device embodiment, with the same technical effect achieved.

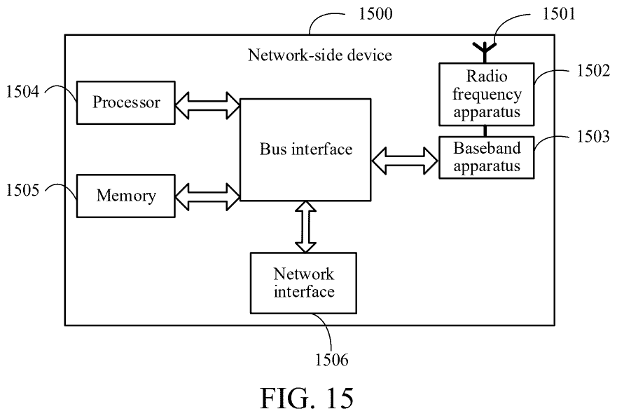

For example, an embodiment of this application further provides a network-side device. As shown in FIG. 15, the network-side device 1500 includes an antenna 1501, a radio frequency apparatus 1502, a baseband apparatus 1503, a processor 1504, and a memory 1505. The antenna 1501 is connected to the radio frequency apparatus 1502. In an uplink direction, the radio frequency apparatus 1502 receives information through the antenna 1501, and sends the received information to the baseband apparatus 1503 for processing. In a downlink direction, the baseband apparatus 1503 processes to-be-sent information, and sends the information to the radio frequency apparatus 1502; and the radio frequency apparatus 1502 processes the received information and then sends the information through the antenna 1501.

The method performed by the network-side device in the foregoing embodiments may be implemented in the baseband apparatus 1503, and the baseband apparatus 1503 includes a baseband processor.

The baseband apparatus 1503 may include, for example, at least one baseband board, where a plurality of chips are disposed on the baseband board. As shown in FIG. 15, one of the chips is, for example, the baseband processor, which is connected to the memory 1505 through a bus interface, to invoke a program in the memory 1505 to perform the operations of the network-side device shown in the foregoing method embodiments.

The network-side device may further include a network interface 1506. The interface is, for example, a common public radio interface (CPRI).

For example, the network-side device 1500 in this embodiment of this application further includes instructions or a program stored in the memory 1505 and capable of running on the processor 1504, and the processor 1504 invokes the instructions or the program in the memory 1505 to perform the method performed by the modules shown in FIG. 11 to FIG. 12, with the same technical effect achieved. To avoid repetition, details are not described herein again.

An embodiment of this application further provides a readable storage medium. The readable storage medium stores a program or instructions. When the program or the instructions is/are executed by a processor, the processes in the data collection method embodiments are implemented, with the same technical effect achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or a compact disc.

An embodiment of this application further provides a chip. The chip includes a processor and a communication interface. The communication interface is coupled to the processor. The processor is configured to run a program or instructions to implement the processes in the data collection method embodiments, with the same technical effect achieved. To avoid repetition, details are not described herein again.

It should be understood that the chip provided in this embodiment of this application may also be referred to as a system-level chip, a system on chip, a chip system, a system-on-a-chip, or the like.

An embodiment of this application further provides a computer program or program product. The computer program or program product is stored in a storage medium. The computer program or program product is executed by at least one processor to implement the processes in the data collection method embodiments, with the same technical effect achieved. To avoid repetition, details are not described herein again.

An embodiment of this application further provides a communication system, including a terminal and a network-side device. The terminal is configured to perform the processes in FIG. 2 or FIG. 10 and the foregoing method embodiments, and the network-side device is configured to perform the processes in FIG. 2 or FIG. 10 and the foregoing method embodiments, with the same technical effect achieved. To avoid repetition, details are not described herein again.

It should be noted that the terms “include”, “comprise”, or any of their variants in this specification are intended to cover a non-exclusive inclusion, so that a process, a method, an object, or an apparatus that includes a list of elements not only includes those elements but also includes other elements that are not expressly listed, or further includes elements inherent to such a process, method, object, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the shown or described order, but may also include performing functions in a substantially simultaneous manner or in a reverse order depending on the functions involved. For example, the described method may be performed in an order different from that described, and steps may be added, omitted, or combined. In addition, features described with reference to some examples may be combined in other examples.

According to the foregoing descriptions of the implementations, it is understood that the methods in the foregoing embodiments may be implemented by using software in combination with a necessary common hardware platform, or certainly may be implemented by using hardware. However, in most cases, the former is an example implementation. Based on such an understanding, the technical solutions of this application essentially or the part contributing to the conventional technology may be implemented in a form of a computer software product. The computer software product is stored in a storage medium (for example, a ROM/RAM, a magnetic disk, or a compact disc), and includes several instructions for instructing a terminal (which may be a mobile phone, a computer, a server, an air conditioner, a network device, or the like) to perform the methods in the embodiments of this application.

The foregoing describes the embodiments of this application with reference to the accompanying drawings. However, this application is not limited to the foregoing specific implementations. The foregoing specific implementations are merely examples, but are not limitative. Inspired by this application, persons of ordinary skill in the art may further make many modifications without departing from the purposes of this application and the protection scope of the claims, and all the modifications shall fall within the protection scope of this application.

What is claimed is:

1. A data collection method, comprising:
constructing, by a first device, a first sample dataset, wherein first sample data in the first sample dataset comprises sensitive information of the first device;
determining, by the first device, a first output of a first model based on the first sample dataset, wherein the first model is used for performing feature extraction on the sensitive information of the first device; and
sending, by the first device, first information to a second device, wherein the first information is determined based on the first output of the first model, and the first information is used for the second device to determine target sample data, wherein
a group of target sample data comprises first target information and second target information, the first target information is information determined based on a first output corresponding to the first sample data, the second target information is determined based on second sample data, and the second sample data comprises sensitive information of the second device.

2. The method according to claim 1, wherein before the constructing, by a first device, a first sample dataset, the method further comprises:
receiving, by the first device, second information from the second device, wherein
the second information comprises at least one of beam requirement information and model version information, the beam requirement information is used for the first device to construct the first sample dataset, and the model version information is used for determining a version of the first model.

3. The method according to claim 2, wherein the first target information meets any one of the following conditions:
the first target information is the first output, or the first target information is information obtained by the first device by post-processing the first output based on a post-processing configuration;
when the first model comprises a first sub-model and a second sub-model, the first target information is the first output, the first output is output information of the second sub-model, an input of the first sub-model is the sensitive information of the first device or information obtained by preprocessing the sensitive information of the first device based on a preprocessing configuration, and an input of the second sub-model is output information of the first sub-model or information obtained by post-processing the output information of the first sub-model based on a post-processing configuration; or
when the first model comprises a second sub-model and N sequentially connected first sub-models, the first target information is the first output, the first output is output information of the second sub-model, an input of the 1^{st} first sub-model is the sensitive information of the first device or information obtained by the first device by preprocessing the sensitive information of the first device based on a preprocessing configuration, an input of an n^{th} first sub-model is output information of an (n−1)^{th} first sub-model or information obtained by post-processing the output information of the (n−1)^{th} first sub-model based on a post-processing configuration, and an input of the second sub-model is output information of an N^{th} first sub-model or information obtained by post-processing the output information of the N^{th} first sub-model based on a post-processing configuration, wherein
N is an integer greater than 1; n is a positive integer less than or equal to N; the preprocessing configuration comprises at least one of the following: a one-hot encoding dictionary configuration, a data normalization parameter configuration, a data regularization parameter configuration, and a data standardization parameter configuration; and the post-processing configuration comprises a sparsity configuration and/or a privacy configuration.

4. The method according to claim 3, wherein the second information further comprises at least one of first indication information or second indication information, the first indication information is used for indicating whether the second device supports the first device in performing the post-processing, and the second indication information is used for indicating the preprocessing configuration and/or the post-processing configuration.

5. The method according to claim 4, wherein when the second indication information is used for indicating the post-processing configuration, the second indication information is further used to indicate at least one first sub-model among of the N first sub-models to which the post-processing configuration is applied.

6. The method according to claim 3, wherein the sparsity configuration comprises at least one of the following: a quantization target precision, a quantization precision difference, or a pruning zeroing threshold.

7. The method according to claim 1, wherein when the first device is a terminal, before the constructing, by a first device, a first sample dataset, the method further comprises:
sending, by the first device, a first identification request message to the second device, wherein the first identification request message comprises at least one of the following:
a version of the first model;
a version of a second model of the second device;
an output length of the first model;
output use information of the first model;
third indication information, wherein the third indication information is used for indicating a preprocessing configuration of the first model and/or a post-processing configuration of the first model;
a model ID of the first model; or
an ID of a second model of the second device, wherein
the output use information comprises at least one of the following: an interface between an output of the first model and a third model; or a calculation operation on an output of the second model of the second device and an output of the first model.

8. The method according to claim 1, wherein when the first device is a base station, before the constructing, by a first device, a first sample dataset, the method further comprises:
receiving, by the first device, a second identification request message from the second device, wherein the second identification request message comprises at least one of the following:
a version of the first model;
an output length of the first model;
third indication information, wherein the third indication information is used for indicating a preprocessing configuration of the first model and/or a post-processing configuration of the first model; or
a model ID of the first model.

9. The method according to claim 1, wherein the first information comprises at least one of the following:
at least a part of the first target information;
a sample indication associated with at least a part of the first target information;
a version of the first model;
an output length of the first model; or
measured beam quality.

10. The method according to claim 9, wherein the sample indication comprises a single-sample indication or a multi-sample indication, wherein the single-sample indication comprises any one of the following: a sample ID, a sample collection timestamp, or a measurement resource ID; and
the multi-sample indication comprises any one of the following:
sample IDs of all first sample data;
sample collection timestamps of all first sample data;
a starting sample ID and a total quantity of samples;
a starting sample ID and an ending sample ID; or
a sample collection starting timestamp and a sample collection ending timestamp.

11. The method according to claim 1, further comprising:
sending, by the first device, third information to the second device, wherein the third information comprises first target output information, the third information is used for the second device to determine the target sample data paired with the first information, and the first target output information is the first target information determined by the first device based on an output of the first model that is associated with a mode ID, wherein
the first information comprises a mode ID for measurement and measured beam quality, and the mode ID is used for indicating a mode corresponding to a transmit/receive beam pair, or when the first device is a base station, the mode ID is used for indicating a mode corresponding to a transmit beam of the base station.

12. The method according to claim 1, further comprising:
sending, by the first device, a first target set to the second device, wherein the first target set is used for the second device to determine the target sample data paired with the first information, and the first target set comprises first target information determined based on different first sample data and an output ID associated with the first target information, wherein
the first information comprises a target output ID, and the target sample data comprises first target information associated with the target output ID.

13. The method according to claim 1, wherein the first information comprises a first output ID, or a second target set and a first output ID,
wherein the second target set comprises first target information determined based on different first sample data; and the first output ID is used for indicating first target information associated with a measurement resource; and
wherein when the first device is a base station, the first output ID is determined based on a receive beam ID corresponding to the measurement resource, or is determined based on a preprocessing indication, a post-processing indication, and a receive beam ID corresponding to the measurement resource.

14. The method according to claim 1, wherein the first information meets at least one of the following conditions:
the first information in one transmission comprises a first part of sample data in a group of target sample data, wherein the first part of sample data comprises at least one of the following: at least a part of the first target information and a part of information in measured beam quality; or
the first information in one transmission comprises a second part of sample data in at least two groups of target sample data, wherein the second part of sample data comprises the first target information and measured beam quality.

15. The method according to claim 2, wherein when the first device is a terminal, the second information is carried in a channel state information CSI report configuration.

16. The method according to claim 2, wherein when the first device is a terminal and the second device is a base station, after the receiving, by the first device, second information from the second device, the method further comprises:
performing, by the first device, measurement on a configured reference signal resource, to obtain measured beam quality, wherein
the sensitive information of the first device is beam information and/or antenna information for measurement.

17. The method according to claim 1, wherein before the constructing, by a first device, a first sample dataset, the method further comprises:
obtaining, by the first device, fourth information from a model identification device, wherein the fourth information is used for indicating at least one of the following:
a version of a second model of the second device;
a version of the first model;
an output length of the first model;
an interface between an output of the first model and a third model;
a calculation operation on an output of a second model of the second device and an output of the first model;
a model ID of a second model of the second device;
a model ID of the first model;
a model ID of a third model; or
third indication information, wherein the third indication information is used for indicating a preprocessing configuration of the first model and/or a post-processing configuration of the first model, wherein
the third model is an artificial intelligence AI model for performing inference and prediction based on the target sample data.

18. The method according to claim 1, wherein the sensitive information of the first device comprises at least one of beam information or antenna information of the first device, and the sensitive information of the second device comprises at least one of beam information or antenna information of the second device.

19. A data collection method, comprising:
receiving, by a second device, first information from a first device, wherein the first information is determined based on a first output of a first model, an input of the first model is determined based on a first sample dataset, and first sample data in the first sample dataset comprises sensitive information of the first device; and
determining, by the second device, target sample data based on the first information, wherein
a group of target sample data comprises first target information and second target information, the first target information is information determined based on a first output corresponding to the first sample data, the second target information is determined based on second sample data, and the second sample data comprises sensitive information of the second device.

20. A first device, comprising a processor and a memory storing instructions that, when executed by the processor, cause the first device to perform operations comprising:
constructing a first sample dataset, wherein first sample data in the first sample dataset comprises sensitive information of the first device;
determining a first output of a first model based on the first sample dataset, wherein the first model is used for performing feature extraction on the sensitive information of the first device; and
sending first information to a second device, wherein the first information is determined based on the first output of the first model, and the first information is used for the second device to determine target sample data,
wherein a group of target sample data comprises first target information and second target information, the first target information is information determined based on a first output corresponding to the first sample data, the second target information is determined based on second sample data, and the second sample data comprises sensitive information of the second device.
